(19) United States
(12) Patent Application Publication
(10) Pub. No.: US 2026/0316401 A1
(43) Pub. Date: Oct. 15, 2026

(54) FDM Processing

(71) Applicant: Addman Intermediate Holdings, LLC, Fort Myers, FL (US)

(72) Inventor: Daniel Saberton, Bonita Springs, FL (US)

(21) Appl. No.: 19/407,744

(22) Filed: Dec. 3, 2025

Related U.S. Application Data
(60) Provisional application No. 63/727,313, filed on Dec. 3, 2024.

(51) Int. Cl. B29C 64/40; B22F 10/18; B22F 10/47; B22F 10/80; B29C 64/118; B29C 64/386; B33Y 10/00; B33Y 50/00

(52) U.S. Cl. CPC B29C 64/40; B22F 10/18; B22F 10/47; B22F 10/80; B29C 64/118; B29C 64/386; B33Y 10/00; B33Y 50/00; B22F 2998/10

(57) ABSTRACT

An FDM irregularly shaped additive manufactured object has infill deposited structural support spaced apart structures such as pillars in any void or beneath an overhang of grater than about 45 degrees extending downwardly therefrom to a surface therebelow. The infill may be removed or kept permanent after manufacture is completed.

### CROSS-REFERENCE TO RELATED APPLICATION

This application claims the benefit of and priority to copending U.S. Provisional Patent Application Ser. No. 63/727,313, filed on Dec. 3, 2024, for “Improved FDM Processing,” the disclosure of which is hereby incorporated by reference in its entirety, including the drawings.

### PRIOR ART

The 3D printing or additive manufacturing of various parts and objects from various synthetic resinous materials using fused deposition modeling (FDM) or fused filament fabrication (FFF) which is well-known and widely used. However, as is also known, the so-manufactured or printed parts have inherent strength issues, especially where the parts or objects have irregular geometries and angularity.

One such inherent problem encountered in 3D printing or additive manufacturing using FDM or FFF processing is adding the requisite structural strength to parts or objects having internal cavities or curvilinear surfaces or other geometry.

The art has addressed this problem by the utilization of, for example, vertical rays or beams being integrated into the structure as it is being printed and which are thereafter removed from the final object. This is shown in U.S. Pat. No. 9,524,357. However, the utilization of the vertical beams is constrained by the inability to provide the requisite angularity to the beads to reinforce those portions of the parts where such is necessary.

Additionally, U.S. Patent Publication No. 2019/0079492 teaches the use of a self-supporting lattice network, either permanent or temporary, for imprinting the requisite structural strength of the final printed object. However, this still does not overcome the strength issue with objects having irregular surfaces.

The present invention seeks to improve upon these and other deficiencies in the prior art by providing an improved method of reinforcing an object or structure during FDM or FFF 3D printing.

### BACKGROUND OF THE INVENTION

The present invention concerns an improved method of defining and providing necessary support strengthening regions in an FDM or FFF additive manufactured or 3D printed object.

The utilization of additive manufacturing objects using FDM has advantages over other processes. FDM additive manufacturing enables production of objects having the necessary properties for applications that demand precise tolerances, durability and stability in different environments. While additive manufacturing deploys many of the same traditional manufacturing materials normally used in traditional manufacturing processes like injection molding, it cannot provide this broad spectrum of properties. Further, FDM enables the production of objects with complex geometries. Oftentimes, the nature of the geometry, such as curves, .e.g, greater than 45°, overhangs, or the like, requires that certain portions or regions of the part or object be “supported.” To date, such cannot be satisfactorily achieved using FDM additive manufacturing.

The present invention is directed to creating objects using FDM additive manufacturing that defines the regions needing such support and providing the same to the object.

### BRIEF DESCRIPTION OF THE DRAWINGS

FIG. 1 is a flowchart showing the essential steps in carrying out the process hereof;

FIG. 2 is a perspective view of an exemplary modeled printed object in accordance herewith;

FIG. 3 is a cut-away top view showing the support structures used herein;

FIG. 4 is a perspective view showing the reinforcing rays created herein; and

FIG. 5 is a perspective view showing a reinforced printed object.

### DETAILED DESCRIPTION OF THE INVENTION

As is known to the skilled artisan, typically, an object to be 3D printed is computer modelled using computer aided design (CAD) (e.g., parametric modeling, direct modeling, mesh modeling, etc.) other modeling software. While the model can be manually created, computer modeling is preferred.

The object and/or model may be saved as a mesh (e.g., a mesh of triangles) as, for example, an STL, OBJ, PLY, 3MF, AMF, etc. file format. In a computer, the modelling data, for example, triangular mesh data representing the 3D model, is transmitted to a slicer. As the name suggests, a slicer performs the role of slicing the 3D model into a series of layers.

The slicer determines how each layer of the sliced model should be printed and the tool path that a printer needs to follow to correctly print the given layer of the model.

Prior to slicing, a computer and/or software (e.g., computer executable instructions) may “tile” the surface of the object to be printed with triangles or other geometries. These geometries, which are usually triangles, create a mesh substantially without any gaps or overlaps (tessellation).

For example, with an STL mesh file, the computer and/or software may create a list of three-dimensional coordinates grouped into sets of three and a vector.

The slicer, creating toolpath layers of the object to be printed, may determine if and where support material is necessary to support layers of the object to be printed. The slicer may also create the tool path for the deposition of the support material. Alternatively, based upon the tessellated object and/or otherwise determined areas of the object which need further structural support, a sensor may detect the material flow at any given point. The sensor may then transmit the information or data to a controller which may adjust the flow rate of the material being deposited and applies any variables or alterations to the standard flow rate which has been pre-determined for the manufacture of the object. The adjustments in flow rate enable the added or needed material to impart the necessary structural support to the object.

The need to provide or supplement structural support is ordinarily encountered with an irregularly shaped object, such as where an overhang(s), a curve (e.g., beyond 45°) or other user-specified angle exists in the object to be printed.

As noted above, the present disclosure enables an improved method for providing such additional or supplemental structural support to an additive manufactured (e.g., FFF, FDM additive manufactured) object.

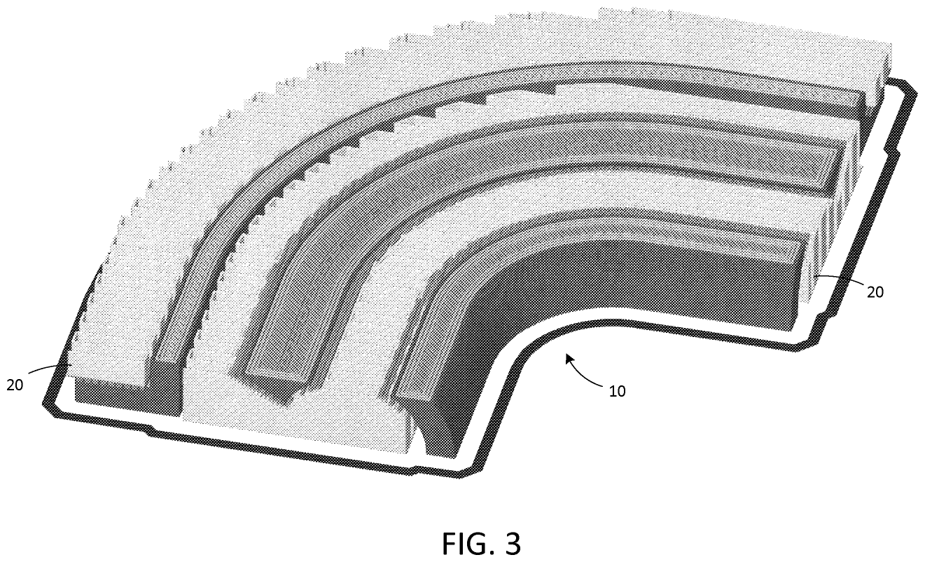

Now, with reference to the drawing and in accordance with the present invention, there is depicted therein an object or product, generally denoted as 10 (FIG. 3), produced according to the method hereof and having improved structural support regions or volumes.

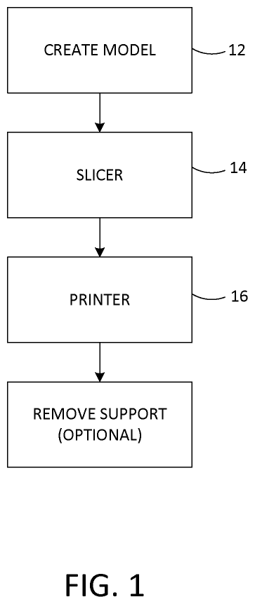

As shown in FIG. 1, the steps shown at 12 in the method hereof generally comprise creating a 3D model of the object or part to be printed, preferably using a computer, for example, via CAD. Thereafter, regardless of the modeling method, the model criteria will be inputted using suitable software. Ordinarily (e.g., parametric modeling, direct modeling, and/or mesh modeling, etc.) is used to model the object. For example, Non-Uniform Rational B-Splines (NURBS) may be used as the modeling software. However, it is to be understood that other software and/or modeling architectures, may be used for modeling the object.

Regardless of the modeling software used, the object to be printed may be converted to a 3D mesh, for example of triangles. Although surface geometries other than triangles can be used where there are no overlaps or gaps (often called tiles) for creating a computerized structural build of a three-dimensional model, 3D mesh is particularly useful in creating curvilinear and other complex or irregular geometries.

In modeling an object, triangles are the most often used polygons in 3D mesh models. Triangles are used because they are amenable to modeling many types of objects easily and accurately. This creation of surface triangulation is otherwise known as tessellation.

In one aspect or non-limiting embodiment hereof, at step 12, the computer may collect a series of data which is inputted and modeled via CAD.

Further at step 12, the computer may then create a mesh format file (e.g., STL, 3MF, etc.) from the CAD model of the object to be printed.

Depending on the CAD modeling software used, the designed model of the object to be printed is represented in different file formats including STL (stereolithic), as noted above. However, again, other useful software includes 3MF (3 D manufacturing format), OBJ, which is a mesh file and AMF (additive manufacturing file format) or any other 3D CAD format may be used herein. Preferably, STL, OBJ, 3MF, or AMF is used.

At step 12, the computer may permit scaling and alignment options. These capabilities allow smaller or larger versions of 3D models to be produced. Once modeled, at step 14, the scaled model is sent to a slicer. The slicer calculates and divides the digital part into layers.

The slicer, for example, operant at step 14, may be a computer and/or software executable on a computer, which may be CAM (computer-aided manufacturing) software. Such software may take the model (e.g., mesh model) created at step 12, which, as noted, may be a CAD generated 3D model or from a manually created model of the part to be printed which then converts the inputs into a form or format that a printer can understand and optimize (e.g., at step 16). For example, at step 14 the slicer may convert the model (e.g., mesh model) into a instructions for the printer to create the modeled part.

Information related to the 3D printing, such as material specifications, layer height, and extruder type may be first inputted into the slicer. The slicer may use such information to create the instructions for the printer, for example, prior to transmitting the instructions to a printer. At step 16, the slicer and/or or computing device executing the slicer software may send the printing instructions to the printer.

Essentially, the slicer, for example, at step 14, may act as a middleman (CAM software) between a 3D CAD model which will be saved in one of the file formats, for example, described herein.

The printer, for example, operant in step 16, may comprise an extruder, or the like.

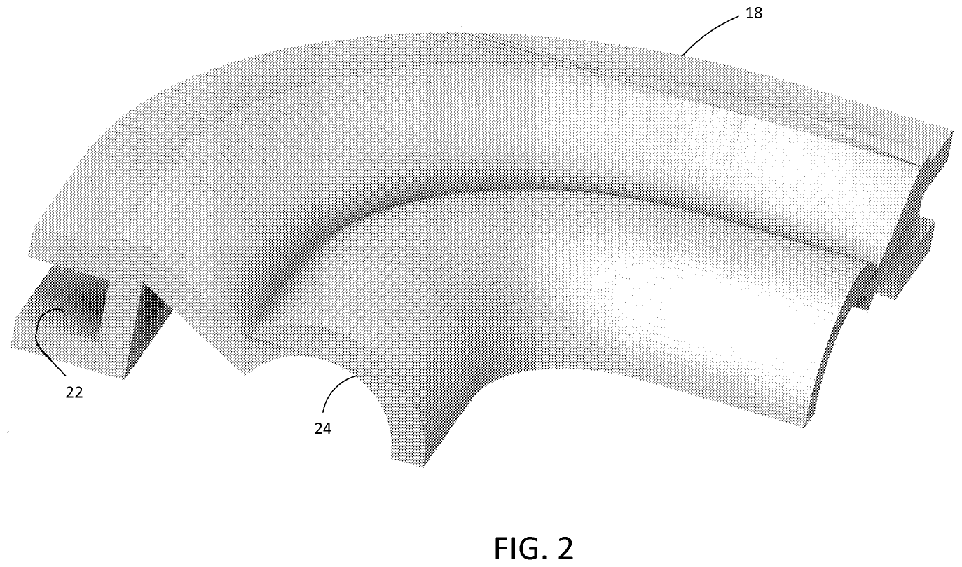

Referring now to FIGS. 2, 4 and 5, there is shown therein an irregular object 18 having voids 22 and/or overhangs 24 within a volume(s) 25. The voids 22 may be defined by object walls surrounding the void 22. In response to (e.g., based on) the inputs and/or instructions from the slicer (for example, created at step 14), the printer (for example at step 16) fills the volume(s) as previously calculated from the modeling, with supporting infill.

As shown (e.g., in FIGS. 3, 4, and 5), the infill may comprise a plurality of infill support structure(s) 20 (e.g., pillars) which are inserted or deposited within the voids 22 or beneath the overhangs 24 to either fill the voids 22 or are deposited beneath the overhang 24. The support structure(s) may be aligned and disposed in a substantially spaced apart vertical path along the volume 25 of the part or object 18 being printed.

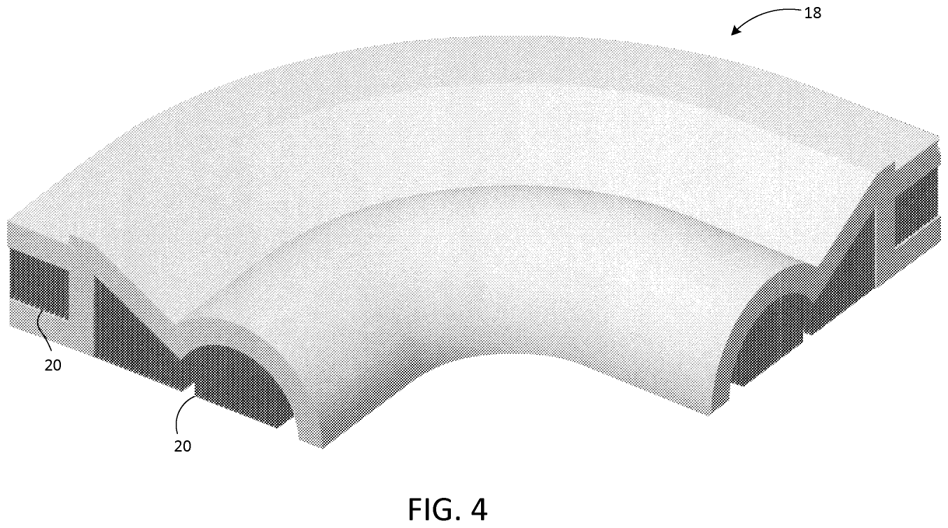

The support structures 20 may comprise pillar structures. For example, the support structures may comprise a plurality of substantially evenly spaced apart support structures 20 (e.g., pillar structures). The plurality of support structures 20 may extend downwardly from an under surface of the model (e.g., from an under surface of the overhang), to a surface therebelow. Each of the support structures 20 may comprise substantially separate structures. Additionally or alternatively, the support structures 20 may comprise substantially separate structures attached at the top and or bottom by one or more layers of deposited material. Moreover, in some configurations, the support structures 20 may be substantially hollow (e.g., comprising only outer walls), or may comprise infill for support of the support structures 20. Additionally or alternatively, the support structures 20 may be substantially solid. The support structures 20 may provide improved support for voids 22 and/or overhangs 24, while also improving the removability of the support material, for example, post printing. The slicer (e.g., at step 14 described above) may be configured to automatically produce a series of support structures 20, for example, based on a user selection for support material and based on the object to be printed geometries. For example, the user may select the size (e.g., width of each support structure 20) and/or spacing (e.g., between adjacent and/or neighboring support structures 20) of the support structures 20, and the slicer may automatically generate the selected sized and spaced support structures 20 for support as determined for the object. Moreover, a user may select one size and/or spacing of the support structures 20 for one area of the object and select a second different size and/or spacing of the support structures 20 for a second different area of the object. Additionally or alternatively, the slicer may determine optimal size(s) and/or spacing(s) of the support structures 20 to optimize for support and/or material conservation. For example, referring to FIG. 3, the support structures 20 may be determined and/or deposited in a single column. Additionally or alternatively, referring to FIG. 4, the support structures may be deposited in rows and columns (e, g., a grid of support structures 20).

As shown, where necessary and as calculated (e.g., by the slicer in step 14), the support structures 20 are disposed within the volume 25 underneath the overhangs 24 of the object 18, including the underlying upper curvilinear surface overhang thereof. The structure 20 when extruded extends downwardly to a base plate (not shown) or downward to the top of a surface of the object that resides under the overhang.

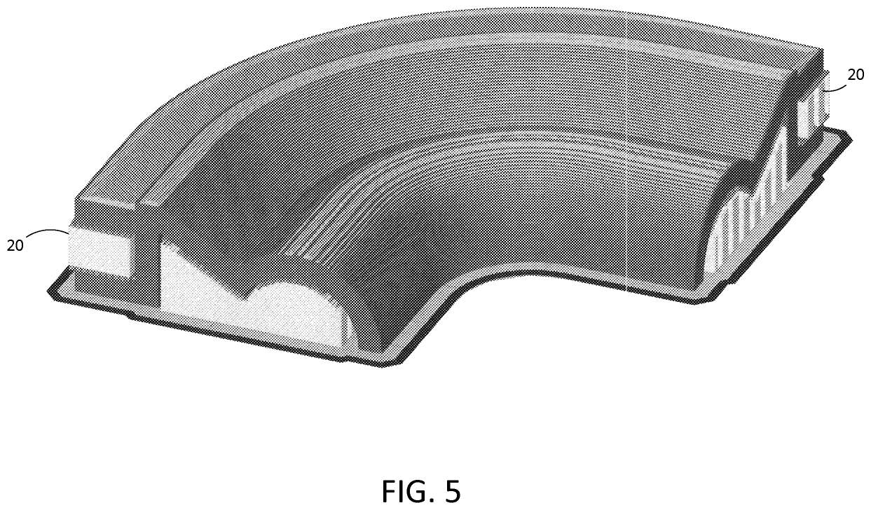

As shown in FIG. 5, the support structure 20, whether permanent or removable, essentially encompasses the required supported regions of the printed object.

During printing, the support structures 20 are extruded downwardly toward the base plate, along with the defined object.

Once the printing is complete and the object cools, the resulting additional support created by the support structure infill may be removed or otherwise may become permanent to provide the final product.

When using FDM, any suitable materials which are amenable to such printing, including thermoplastics and, in some instances, powder metals may be used. Suitable thermoplastics include ABS, PLA, TPU, Nylon, PEEK and the like. It should be noted that the infill thermoplastic material need not be the same thermoplastic used to manufacture the object.

It is to be appreciated from the preceding that it has been shown that the present invention provides an FDM or FFF or similar printing process which improves the definition of the support necessary for printing objects having unique geometric patterns and/or overhangs and other curvilinear surfaces. The present invention improves the definition of the support areas defined by the software which represents the support area volume.

Also, the present invention enables the user to modify the supported regions manually, if desired.

1. A method for improving the structural strength of an additive manufactured object having a volume of at least one void or overhang of at least 45°, comprising:
depositing at least two spaced apart infill structural support pillars in the volume.

2. The method of claim 1 wherein:
The object is a 3D modelled FDM additive manufactured object using STL or 3D mesh.

3. The method of claim 1 which further comprises:
(a) initially 3D modeling in a computer, the object to be printed to collect printing data;
(b) transmitting the collected data to a slicer, the slicer tessellating the object; and
(c) therefrom, transmitting printing instructions to a printer which prints the object layer by layer, and
wherein the printer comprises an extruder which prints the object including the at least two pillars downward toward a base plate or other underlying surface.

4. The process of claim 3 wherein the object is manufactured from a thermoplastic material selected from the group consisting of ABS, PLA, TPU, Nylon, PEEK, CF-PEEK and the like.

5. The process of claim 3 wherein the object is manufactured from a metal powder.

6. The method of claim 1 where the volume is a void.

7. The method of claim 1 wherein the volume is beneath an overhang, the infill pillars extending downwardly from the under surface of the overhang to a surface therebelow.

8. The method of claim 1 wherein:
the infill is removed after the manufacture is completed.

9. The method of claim 1 wherein the infill is incorporated into the object after the manufacture is completed.

10. A structurally supported irregularly shaped object additive manufactured according to the method of claim 1.
